(19) United States
(12) Patent Application Publication
(10) Pub. No.: US 2013/0325685 A1
(43) Pub. Date: Dec. 5, 2013

(54) SYSTEM AND METHODS FOR PRIORITIZED MANAGEMENT OF FINANCIAL INSTRUMENTS

(71) Applicant: OptionsXpress Holdings, Inc., (US)

(72) Inventor: David S. Kalt, Chicago, IL (US)

(73) Assignee: OptionsXpress Holdings, Inc., Chicago, IL (US)

(21) Appl. No.: 13/683,323

(22) Filed: Nov. 21, 2012

Related U.S. Application Data
(63) Continuation of application No. 11/241,556, filed on Sep. 30, 2005, now abandoned.
(60) Provisional application No. 60/614,625, filed on Sep. 30, 2004.

(51) Int. Cl. G06Q 40/04

(52) U.S. Cl. CPC G06Q 40/04
USPC 705/37

(57) ABSTRACT

The invention relates to an improved means for interactive computerized communications having a facilitated capability for order entry and order execution, and providing an enhanced range of trading forms and methods to clients of brokerage firms dealing in financial securities. In particular, the invention relates to a type of interactive computerized system and software program that implements an improved mode of online communication between brokerage firms dealing in financial securities and their retail investors, to result in a more efficient and flexible range in the type of allowable trades, and that provides thereby innovative and strategic advantages to individual investors of brokerage firms, for actively managing financial securities held in trading accounts.

### CROSS-REFERENCE TO RELATED APPLICATIONS

This application claims the benefit of U.S. patent application Ser. No. 11/241,556 filed Sep. 30, 2005, which claims the benefit of U.S. Provisional Patent Application No. 60/614,625 filed Sep. 30, 2004.

### FIELD OF THE INVENTION

The present invention is related to the field of prioritized management of financial instruments, and more specifically to an improved mode of online communication relating to automatic trade orders for financial instruments through an online trading account with a financial institution.

### BACKGROUND

The advent of an interactive, computerized means of communication accessible to the public via the Internet has made possible a wide variety of innovative business models and practices. In recent years, entire new sectors of the domestic and international economies have appeared, involving new modes of market commerce, in particular. As a result, many entrepreneurs have begun to envision a “virtual” marketplace, having capability for conducting a vast spectrum of ordinary business transactions with greatly improved efficiency and flexibility.

Securities web sites are popular internet services that allow users to manage investment information. Financial institutions, including brokerages, which make up and/or provide access to various financial instruments, have implemented on-line services that allow investors to engage in trading over data communication networks, including the Internet. For purposes of this invention, financial instrument are securities, stocks, bonds, currencies, options, futures, commodity and derivatives thereof. As used herein, the terms trade and/or trading generally refers to transactions such as buying and/or selling. Any investor having access to the Internet may more directly engaged in trading activity without being forced to speak to a broker to enter their orders in the marketplace for execution.

In addition to the many advantages that may be realized in standard accounting procedures, brokerage firms dealing in financial securities have sought to expand their capabilities for improved interactive computerized communication with their individual retail account investors. Previously, prior to the appearance of the internet, trading orders from such retail investor clients could be communicated only in person or via telephone, whether using voice or fax transmission. Processing such trade orders typically would require a certain amount of lag time before execution, minimally from perhaps a few minutes to as much as several hours or more. More recently, with online communication capabilities becoming widely available, there has now opened a possibility for individual investors of financial brokerage firms to have such orders entered and executed more rapidly, often requiring less than one minute of lag time between the investor entering the order and having receipt of an online trade confirmation in reply, communicated electronically within a very few moments.

In addition, and in further contradistinction to the fairly limited range of standard and traditional types of trading modalities that were previously available to their retail clients, brokerage firms have begun to devise expanded modes of interactive communication where such orders can be made more flexible, so as to provide a greater range of possible trading formulations, allowing individuals managing a trading accounts with their brokerage to define more innovative types of trading orders, such as to include certain conditional or contingent prerequisites that may be advantageous, in a manner that has not been technically feasible.

As an example, retail brokerage firms have traditionally allowed individual investors to specify certain trading orders with buy or sell limits, prescribing that a trade not be executed unless a certain price level for the transaction might become available in the market exchange within a certain limited time frame, usually designated as within one trading day. In a similar manner, such investor trading orders might ordinarily be further conditioned as buy stop, or sell stop orders. Stop orders enable the selection of a price at which an order is activated. For example, a sell stop order entered with an activation price of 40 means an order to sell at market will be activated when the stock trades at 40 or lower. When the order hits the marketplace, it is filled at the best available price. Whereas a buy limit order requires that a purchase not be affected above a certain price, a buy stop order requires buying only at a maximal price level. In the case of sell orders, whereas a sell limit order requires that a sale of financial instrument not be effected below a certain price, a sell stop order requires that the sell order be entered only after accession of a certain price. Limit orders specify the price at which the stop order is activated, and a limit price once the order is activated. Like a stop order, a stop limit order is triggered by a move up or down to a particular price level. Once that level is reached, the order becomes a limit order, which must be executed at a specific price. In contrast, a regular stop order will be executed at the market price rather than at a specified price.

Most brokerage firms would also allow investor orders to request orders where the two conditional contingencies, the limit criterion and the stop-price criterion, are combined. An individual investor might thereby instruct the brokerage firm to either buy or sell at a specified price or better after the market price has advanced or declined beyond a given stop price.

Brokerage firms establishing an interactive or online computerized trading capability as part of their financial services offered to the public might additionally allow their retail investors to specify another type of conditional trading order, involving the designation of a buy or sell stop price level that can be made variable, in accordance with the fluctuations of the market. Such initially non-activated or conditional orders, usually designated as “trailing stop” orders, are defined as buy or sell orders imposing two additional contingencies, involving the market price at the time when the order was entered, and a specified trailing range, or price differential between the current market price and the trigger or activation price. Market price fluctuation beyond such range then causes such orders to become immediately activated, as market orders to buy or sell.

For practical reasons, and because individual traders would usually request a trailing stop order only as part of a protective or defensive strategy, such trailing stops typically would not be combined with any additional criteria involving buy or sell stops, but rather become designated as orders to be executed at the current market price, whenever the trading market price goes beyond, either above or below, the price differential specified by the range of the trailing stop. Thus, the trigger or activation price level for a trailing sell stop can move higher as the market price increases, but it cannot be moved lower from the point of the highest ongoing market price less the trailing differential. Similarly, a designated trigger price for a trailing buy stop can only move lower as the market price decreases, but cannot be adjusted to move any higher than the ongoing current market price minus plus the trailing differential.

As a matter of standardizing procedures, a brokerage firm may oftentimes impose additional restrictions whereby such contingent orders might be held static so as not to become activated for execution at the current market price for some briefly limited period of time subsequent to activation of the trigger point, perhaps a period of one minute or less. Another restriction imposed by brokerage firms might require that such contingent orders only be specified or entered by investors at certain pre-determined incremental price levels, defined usually either in points, or dollar amounts, or fractions thereof, or as a price range limited within an incremental or fractional percentage of the current market price, for any given traded issue or security.

As the extended capabilities of online communication becomes more commonly available, there is an expanded possibility for devising more elaborated trading strategies, whereby an increased potential for innovative forms of interactive trading may be realized.

Therefore a need exists for more elaborate trading strategies providing the investor with more options for managing their financial instruments. The present invention satisfies the demand through a more efficient and expansive method and system for trade order entry and execution. The ability to place trades timely, accurately and reliably is important to maximizing the profit potential of any securities of investment services.

### SUMMARY

The invention relates to an improved means for interactive computerized communications having a facilitated capability for order entry and order execution, and providing an enhanced range of trading forms and methods to clients of brokerage firms dealing in financial securities. In particular, the invention relates to a type of interactive computerized system and software program that implements an improved mode of online communication between brokerage firms dealing in financial securities and their retail investors, to result in a more efficient and flexible range in the type of allowable trades, and that provides thereby innovative and strategic advantages to individual investors of brokerage firms, for actively managing financial securities held in trading accounts.

It is an object of the present invention to facilitate the transactional capabilities of such interactive trading services, by providing retail brokerage investors with an increased range and variety of selectable trading strategies. Innovative types of investor trading orders, selectable by individual clients of the brokerage firm, are incorporated in an online, interactive computerized software program adapted to facilitate such trading communications between brokerage firms dealing in the trade of financial issues and instruments and their individual client investors.

It is another object of the present invention to provide an interactive, computerized online trading platform whereby clients may choose among a range of trading options, to include orders for trading financial instruments where such orders may be made contingent on conditional criteria that individual investors may choose to specify at the same time as entering their initial request for trade.

Yet another object of the invention is to allow for actions to be based on when set conditions are met and/or alternative actions if the condition is not met.

Yet another object of the invention is to reduce the time in takes in changing activation prices on stop orders. Trailing stop orders automatically make adjustments in activation prices without the inconvenience of continuously canceling the old order and entering replacement orders to keep pace with the market. Trailing stops make order entry quick and simple.

Another object of the invention is to place two orders contingent upon each other. The second order is automatically entered upon the execution of a first order. In the alternative, the second order is automatically cancelled upon the execution of a first order.

Yet another object of the invention is to place two or more secondary orders contingent upon a primary order. The secondary orders are automatically entered upon the execution of a primary order. The secondary orders may be contingent upon one another—a first secondary order may be executed or cancelled upon the execution or cancellation of a second secondary order.

The present invention will be further appreciated, and its attributes and advantages further understood, with reference to the detailed description below of some presently contemplated embodiments, taken in conjunction with the accompanying drawings, in which:

### DRAWINGS

FIG. 1 is the main screen of an interactive computerized online trading platform according to the present invention;

FIG. 2 is a trailing stop order screen according to the present invention;

FIG. 3 is a flow chart of a trailing stop order according to the present invention;

FIG. 4 is a contingent-on-stock order screen according to the present invention;

FIG. 5 is a flow chart of a contingent-on-stock order according to the present invention;

FIG. 6 is a one-triggers-other first order screen according to the present invention;

FIG. 7 is a one-triggers-other second order screen according to the present invention;

FIG. 8 is a flowchart of a one-triggers-other order according to the present invention;

FIG. 9 is a one-cancels-other first order screen according to the present invention;

FIG. 10 is a one-cancels-other second order screen according to the present invention;

FIG. 11 is a one-cancels-other flowchart according to the present invention;

FIG. 12 is a one-triggers-two first order screen according to the present invention.

FIG. 13 is a one-triggers-two second order screen according to the present invention.

FIG. 14 is a one-triggers-two third order screen according to the present invention; and

FIG. 15 is one-triggers-two flowchart according to the present invention.

### DETAILED DESCRIPTION

The present invention pertains to order entry and execution of securities. Securities are shares of stock, bonds, options, or any kind of financial asset that can be traded. Orders typically define the security symbol, action, quantity, price and duration. The security symbol is the ticker symbol used to designate the security in the market. Markets include the New York Stock Exchange (NYSE), American Stock Exchange (AMEX), Pacific Exchange (PCX) and National Association of Securities Dealers Automated Quotations (Nasdaq). A market order is an investor order that is to be executed as quickly as possible at the prevailing market price.

Actions are the events that occur to the defined security and are selected by the investor. Actions include: buy, sell, buy to open, buy to close, sell to open, and sell to close. Actions are generally used in futures/options investing to distinguish between establishing versus closing a position. Buy is to exchange, trade or purchase for money or its equivalent. Sell is to exchange or deliver for money or its equivalent. “Buy to close” is an order entered to close a short position. Consequently, a “sell to open” order is always used to open a short position. A “sell to open” order is entered to establish a new short position. Consequently, a “buy to close” order is always used to close a short position. “Buy to open” is an order entered to establish a new long position. Consequently, a “sell to close” order is always used to close a long position. “Sell to close” is an order entered to close a long position. Consequently, a “buy to open” order is always used to open a long position.

Quantity is the amount of a security to be traded, for example shares. An “all or none” (AON) feature associated with quantity allows a trader to buy or sell a specified number of contracts at a single price. The number of contracts must meet or exceed a predetermined threshold level, and these orders must be executed during pit trading sessions. All or none orders are routed to the primary exchange where they are manually held and executed when eligible. Furthermore, these orders are not reflected in the bid/ask quotes. Generally, AON is not recommended on orders of less than 20 contracts since order execution may be affected.

Price includes the type of order. A market order is executed as quickly as possible at the prevailing market price. A limit order allows an investor to buy or sell a predetermined number of shares at a specified price (or better than specified price, if available). Limit orders guarantee a price (or better price than specified), but do not guarantee an execution. A stop order is a contingency order to buy or sell a stock when the market reaches a particular level. When the price reaches that level specified in the stop order, the stop order becomes a market order and is executed at the best possible price. A stop-limit order is like a stop order. This order will be triggered by a move up or down to a particular price level. Once that level is reached, the order becomes a limit order, which must be executed at a specific price. In contrast, a regular stop order will be executed at the market price rather than at a specified price. A “market-not-held-order” is an order issued by an investor allowing the floor broker to use his or her best judgment regarding the price and timing of the trade. A “market on close” is an order executed or triggered just prior to the close of the market. Finally, a “buffered limit” is the desired limit price that will be applied as an offset to the triggered quote, at the time the order is sent to the exchange.

Duration is the length of time the order remains open for fulfillment. A day order is an order to execute a trade that will automatically be cancelled at the end of the trading day if it has not been filled. A “good-until-cancelled” (GTC) is an order to execute a trade that remains open until the trade is completed or the investor cancels the order. Unlike a day order, which expires at the end of a trading day, a GTC order will remain in effect until it is filled or cancelled.

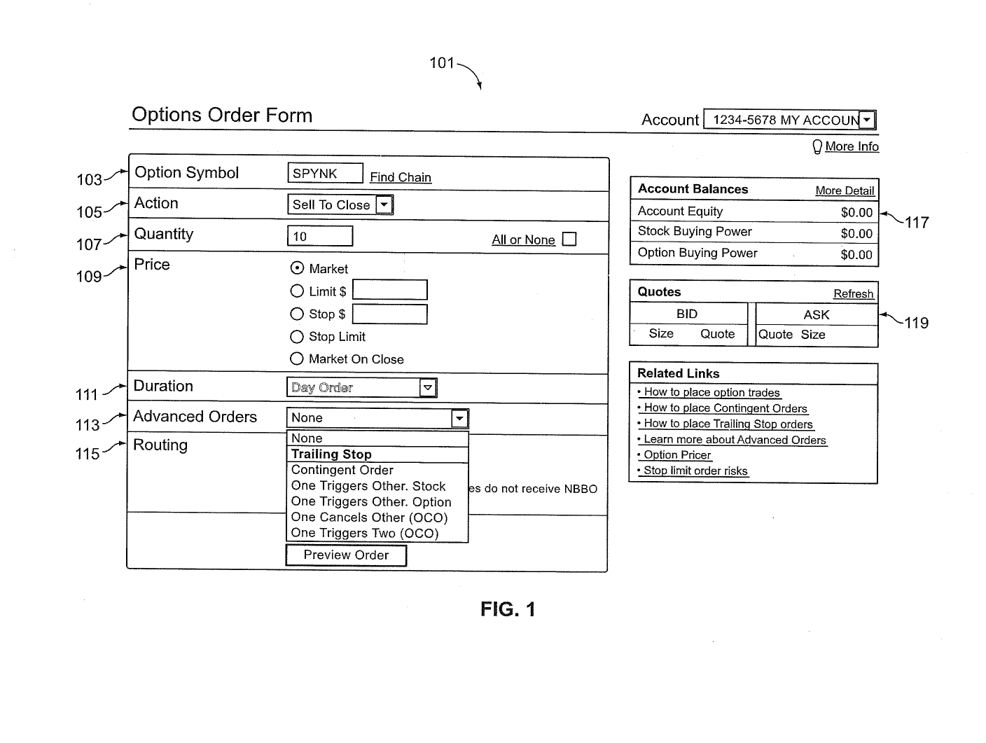

FIG. 1 is the main screen of an interactive computerized online trading platform according to the present invention. The main order screen 101 initiates the order of either an option or stock. The main order screen 101 includes criteria of: symbol 103, action 105, quantity 107, price 109, duration 111, advanced orders 113 and routing 115. The main order screen 101 also includes an account summary 117 and a summary of activity 119 of pending options or stocks particular to the investor.

Symbol 103 is either the option or stock to be traded. Actions 105 include “buy”, “sell”, “sell short”, “buy to cover” for stocks and “buy to open”, “buy to close”, “sell to open” and “sell to close” for options. Quantity 107 is the amount of shares to be traded. Price 109 includes the type of order (Le., market, limit, stop, sop limit, market on close) and, if the type of order selected requires, the amount in points (i.e., dollars). The duration 111 can be a day order or good until cancelled by the investor. Advanced orders 113 offer the investor various trading strategies. Advanced orders 113 include: “contingent order”, “one triggers other” (OTO), one cancels other” (OCO) and “one triggers two” (OT2). Routing 115 is the execution venue in which the order is placed, i.e., the New York Stock Exchange (NYSE), Chicago Board Options Exchange (CBOE), Archapeligo (ARCA).

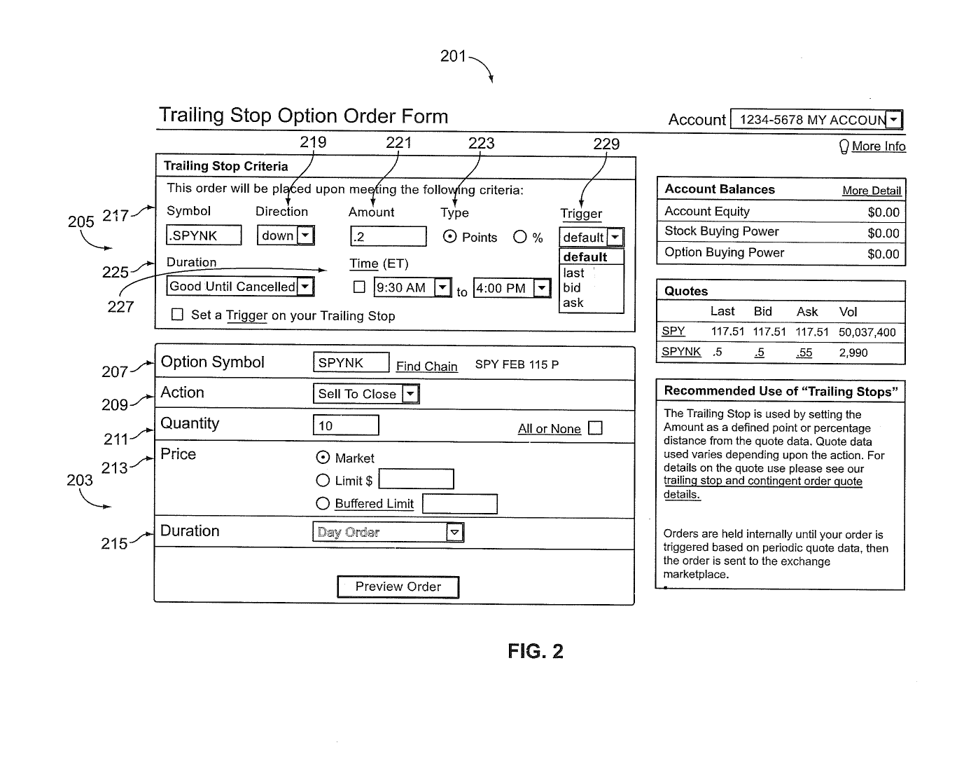

The present invention includes custom advance order screens for online order execution systems including trading and securities management. From this main order screen 101 shown in FIG. 1, the investor can select an advanced order 113. One such advanced order 113 is “trailing stop”. FIG. 2 is a trailing stop order screen 201. The trailing stop feature tracks the market as it rises and keeps the percentage loss constant. In other words, a trailing stop order is a stop order that moves along with a favorable movement in a security. Trailing sell stop orders will move upward a defined distance as long as the security moves upward. Trailing buy stop orders will move downward a defined distance as long as the security moves downward. Just like stop orders, trailing stops can be entered as a sell to protect the downside on a long position, or as a buy to protect a short position against a loss on the upside. Trailing stops allow an investor to take advantage of a move without having to re-enter stop limit orders.

When entering a trailing stop the investor chooses a defined point (i.e. dollar) or percentage distance away from the most favorable quote. The most favorable quote may be the last trade, the bid price or the ask price depending on market conditions when the order is being entered. Trailing stop orders differ from ordinary stop orders in that, as the market price changes, the trailing stop order is automatically adjusted.

An investor defines an order 203 with trailing stop criteria 205. The order 203 includes the stock symbol 207 along with the action 209, for example buy or sell. The order 203 further includes the quantity 211, price 213 and duration 215. Price for trailing stops includes market orders and limit orders. The investor selects the duration 215 of the order 203, for example, day order or good until cancelled by the investor. The order will only be placed if the trailing stop criteria 205 is met. Trailing stop criteria 205 includes: symbol 217, direction 219, amount 221, type 223, duration 225, interval of time 227 and trigger option 229. The symbol 217 of the interested stock or option is entered. The investor selects the direction 219, either up or down, and the amount 221 by type 223, either by points or percentage, by which the stock can fluctuate. If an investor bought an option or stock, and wants protection from a decline in the value of the position, the investor would select the down direction. If an investor wants to protect the position against an increase in value, the up direction is selected. Further, the investor selects the duration 225 the trailing stop criteria is exercisable, either for the day or good until canceled. The investor can enter an interval of time 227 in which the trigger criteria 205 is monitored (poll) during the interval of time 227 specified. If the investor selects a trigger option 229, which include last, bid and ask, the trigger criteria 205 is monitored (poll) using the trigger option 229 that the investor selects. Thus, the trigger criteria 205 is monitored using the last trade, bid or ask.

For example, as shown in FIG. 2, an investor selects SPYNK option and wants to sell 10 options contracts at market price if and only if the price drops down 2 points (i.e., dollars) from the current market price. As a result of selecting a “trailing stop” advanced order, if the price of the option contract increases, the trailing stop criteria 205 adjusts to account for the new increased price point. Thus, if the option contract drops 2 points from the new price point, the 10 options contracts will be sold.

A trailing (stop) trigger uses the bid/ask on entry of the order. On the movement of the trigger, the bid/ask is used—the bid is used on a sell order (of a long position), while the ask is used on buy order (for short positions). On the triggering of the order, either the investor's choice of the bid, ask, last, or the default is used. For the default, the ask or last is used on sell orders, while the bid or last is used on buy orders—in both buys and sells, the last is only used on triggering if it is in between the bid/ask quotes. Like stop orders, trailing stops can be entered as a sell to protect the downside on a long position, or as a buy to protect a short position against a loss on the upside.

Bid is the price point where a buyer is willing to purchase a given stock or option contract. This is the price individual investors typically receive when they sell stock or options at the market. For example, if the bid-ask spread for an option is 4¾-5, a investor looking to sell at-the-market will receive the current bid of 4¾. Ask or ask price is the price point where a seller would be willing to sell a given stock or option contract. Also known as the offer, this is the price individual investors pay when they place a market order. For example, if the bid-ask spread for an option is 3-3¼, the individual investor can expect to pay the ask price of 3¼ to buy the contract. Conversely, the same person looking to sell the contract will get the bid price of $3. The ¼ point spread is earned by the market maker. Last is merely the last bid or ask that was previously entered.

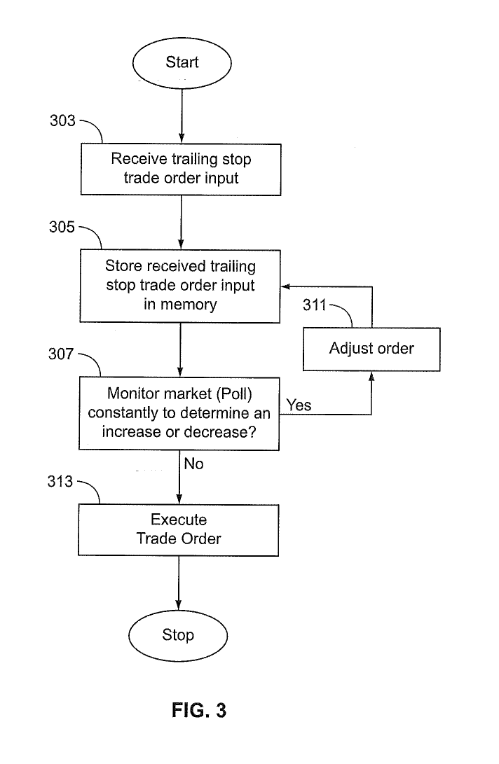

FIG. 3 is a flow chart 301 illustrating the trailing stop order. The trailing stop trade order input is received 303 and stored into memory 305. The market is evaluated 307. If there is an increase or decrease, the trailing stop trade order is adjusted 311 accordingly. If there is no increase or decrease 307, and the trailing stop input 301 is met, the order is executed 313.

As an example, consider a trailing sell stop placed on an option that is currently trading at 5 points. A trailing stop order placed to sell the option at the market if the price declines 1 point provides downside protection at the current moment and for the current price. Suppose, however, that the option rises quickly to 10 points. With the option trading at 10, a different exit point may be desired. The trailing stop order automatically sets the trigger price to 10 points minus 1 point, or 9 points. New trigger points are updated without any input by the investor.

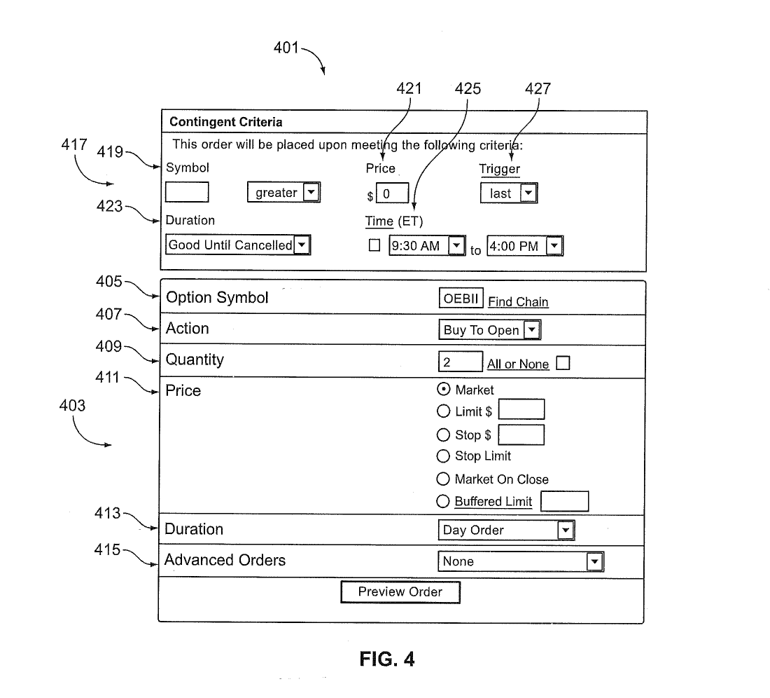

FIG. 4 is a contingent-on-stock order screen 401 according to the present invention. Contingent-on-stock or stop-on-stock is a capability to open or close an option position when a stock or index reaches a desired price level based on the stock or index's last trade price. This gives the investor the ability to place option trades contingent upon an equity stock's price. Contingent-on-stock option orders, stop-on-stock option orders and trailing stop orders described above, are defined as an order placed only if/when the market price for the security (stock or option) specified meets the specified criteria (greater than or less than a price entered). This means that an investor can open or close an option position when a stock, index or option reaches a desired price level based on the security's last trade price.

An investor defines an order 403 and contingent criteria 417. The order 403 includes the option or stock symbol 405 along with the action 407, for example buy to open, buy to close, sell to open, or sell to close. The order 403 further includes the quantity 409, price 411 and duration 413. Price includes market orders, limit orders, stop orders, stop limit orders, market on close and buffered limit. The investor selects the duration 413 of the order 403, for example, day order or good until cancelled by the investor. In addition, the investor also has the option to select an advanced order 415.

The order 403 will only be placed if the contingent criteria 417 is met. Contingent criteria 417 includes: symbol 419, price 421, duration 423, time 425 and trigger 427. If the investor selects a trigger option 427, which include last, bid and ask, the trigger criteria 417 is monitored (poll) using the trigger option 427 that the investor selects. Thus, the trigger criteria 417 is monitored using the last trade, bid or ask. If last is chosen, it will only be used if it is in between the bid and ask. Further, the investor selects the duration 423 the contingent criteria 417 is exercisable, either for the day or good until canceled. The investor can enter an interval of time 425 in which the trigger criteria 417 is monitored (poll) during the interval of time 425 specified.

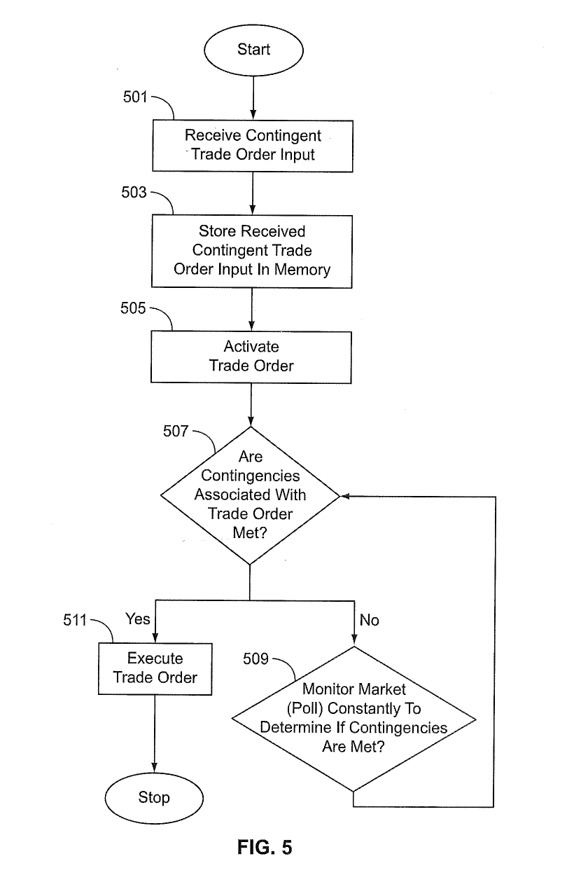

FIG. 5 is a flow chart of a contingent-on-stock order according to the present invention. The contingent trade order input is received 501 and stored into memory 503. The trade order is activated 505. If the contingencies associated with the trade order are not met 507, the market is constantly polled 509. If the contingencies associated with the trade order are met 507, the trade order is executed 511.

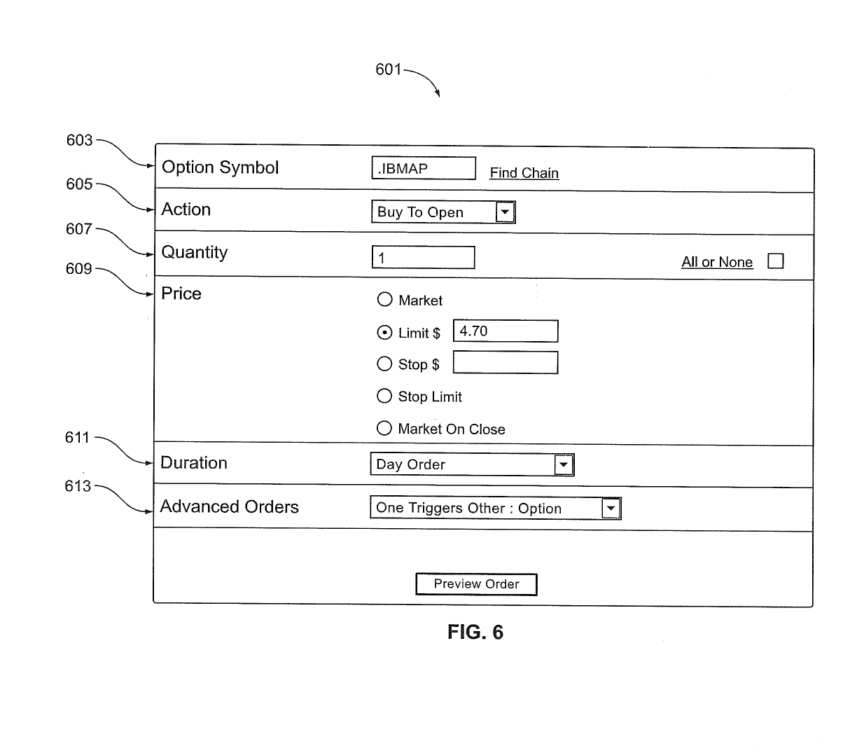

FIG. 6 is a one-triggers-other (OTO) first order screen 601 according to the present invention. One-triggers-other (OTO) allows the investor to enter an initial order and place a second order contingent upon the fill of the first order. This type of order entry can be utilized when trading stocks or options. A common use of the OTO is to place a limit order to buy an option contract at a specific price and then place a sell stop order that activates upon the execution of the initial buy order. For example, an investor places a limit order to buy a stock at a specific price and upon the execution of the initial buy order, a sell stop order is automatically sent to the exchange.

The first order screen 601 initiates the order of either an option or stock. An investor defines an order 601 that includes the stock or option symbol 603 along with the action 605. The order 601 further includes the quantity 607, price 609 and duration 611. Price includes market orders, limit orders, stop orders, stop limit orders and market on close orders. The investor further selects OTO for the advanced order 613. With an OTO trigger, a qualifier is used when multiple stock or option orders are entered and the execution of one order submits a second or alternate order.

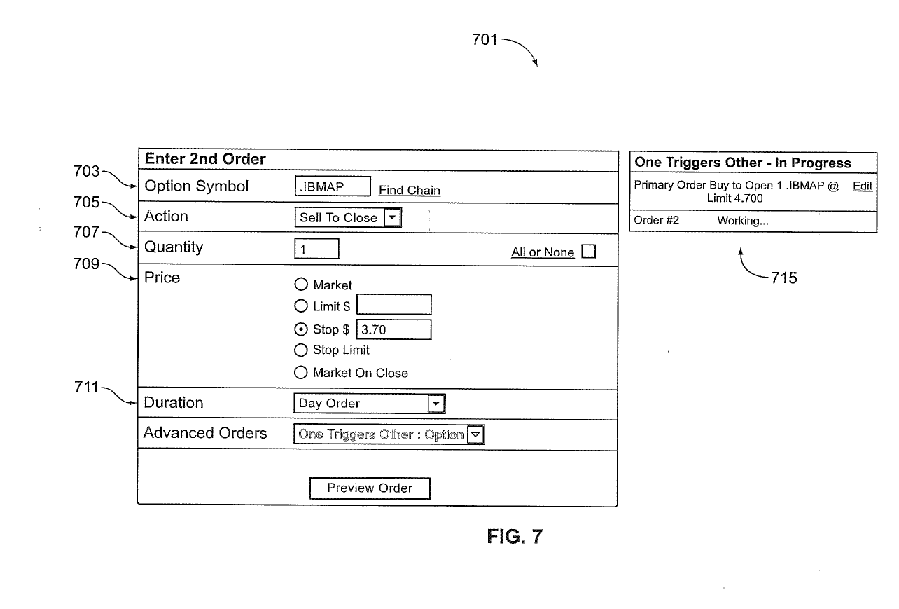

FIG. 7 is a one-triggers-other second order screen according to the present invention. A second order screen 701 is displayed when the one-triggers-other is activated. The second order screen 701 initiates the order of either an option or stock upon execution of the first order 601. An investor defines a second order 701 that includes the stock or option symbol 703 along with the action 705. The order 701 further includes the quantity 707, price 709 and duration 711. The second order screen 701 displays the first or primary order and its status 715.

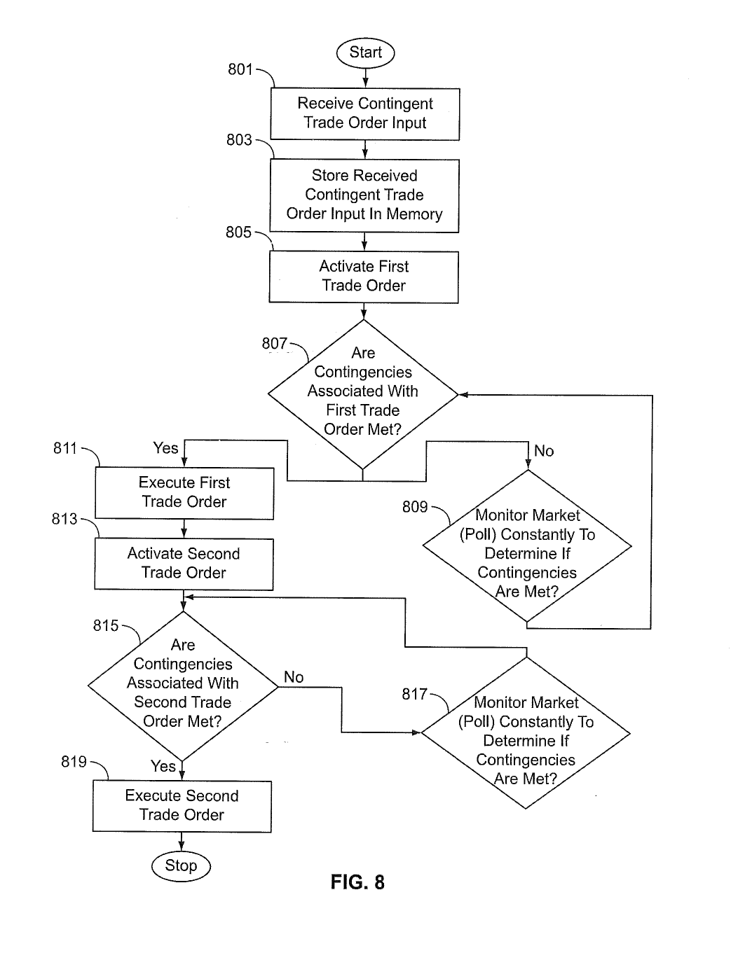

FIG. 8 is a flowchart of a one-triggers-other order according to the present invention. The contingent trade order in put is received 801 and stored into memory 803. The first trade order is activated 805. If contingencies associated with the first trade order are not met 807, the market is monitored 809. If contingencies associated with the first trade order are met 807, the first order is executed 811 and the second trade order is activated 813. If contingencies associated with the second trade order are not met 815, the market is monitored 817. If contingencies associated with the first trade order are met 815, the second order is executed 819 and the second trade order is activated 813.

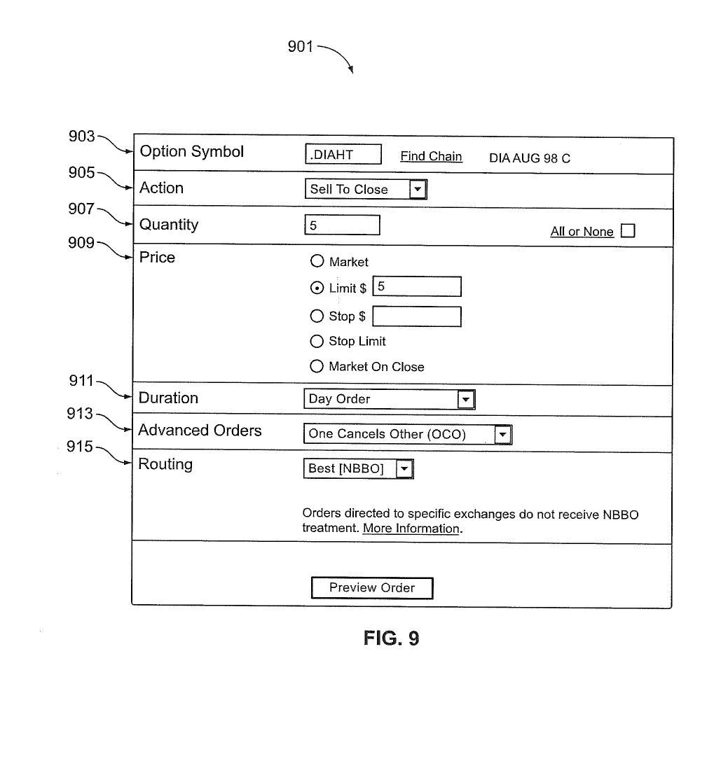

One-cancels-other (OCO) is available online for active money management and reduction in human errors. The OCO feature is automated and integrated with the order screens. FIG. 9 is a one-cancels-other (OCO) order screen 901 according to the present invention. If both orders are linked with OCO, when one order is filled, a cancel order is triggered on the other. With OCO orders, a qualifier is used when multiple orders are entered and the execution of one order cancels a second or alternate order. For example, with OCO an investor can place two orders linked to each other, allowing an investor to place a stop loss order on the same option. Thus, when one order is filled the other order is simultaneously cancelled. One-cancels-other is used primarily as an exit strategy to assist in either capturing gains or avoiding losses. For example, if the position price decreases, a stop loss order cuts the loss, and the limit order is cancelled. As another example, if the position price increases, a limit order attempts to capture the gain, and the stop loss order is cancelled.

An investor defines two orders 901 and 1001. The first order 901 includes the stock or option symbol 903 along with the action 905. The order 901 further includes the quantity 907, price 909 and duration 911. The investor further selects OCO for the advanced order 913 and the routing 915. With an OCO trigger, a qualifier is used when multiple stock or option orders are entered and the execution of one order cancels a second or alternate order.

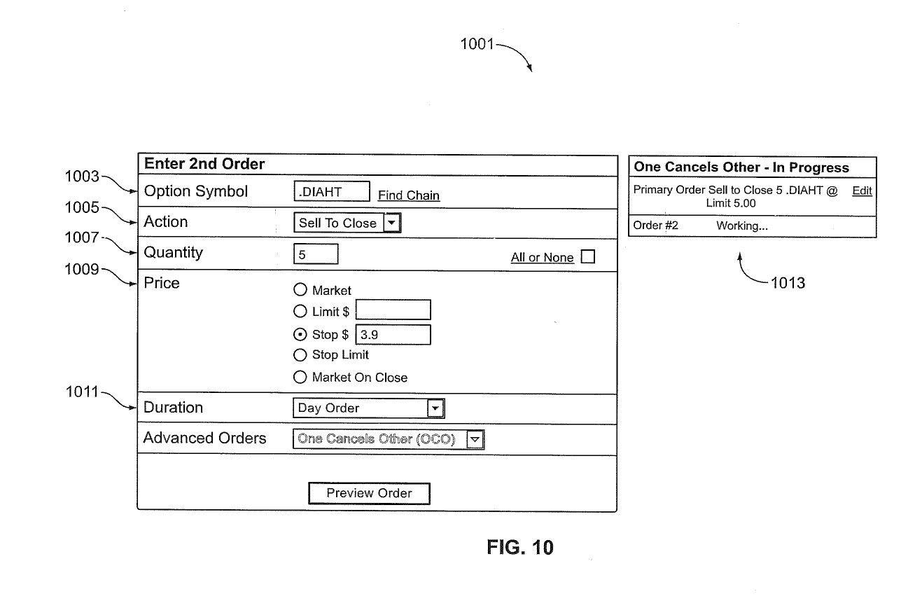

FIG. 10 is a one-cancels-other second order screen 1001 according to the present invention. A second order screen 1001 is displayed when the one-triggers-other is activated. An investor defines a second order 1001 that includes the stock or option symbol 1003 along with the action 1005. The order 1001 further includes the quantity 1007, price 1009 and duration 1011. The second order screen 1001 displays the first or primary order and its status 1013. Either the first order 901 is simultaneously canceled upon execution of the second order 1001, or the second order 1001 is simultaneously cancelled upon the execution of the first order 901.

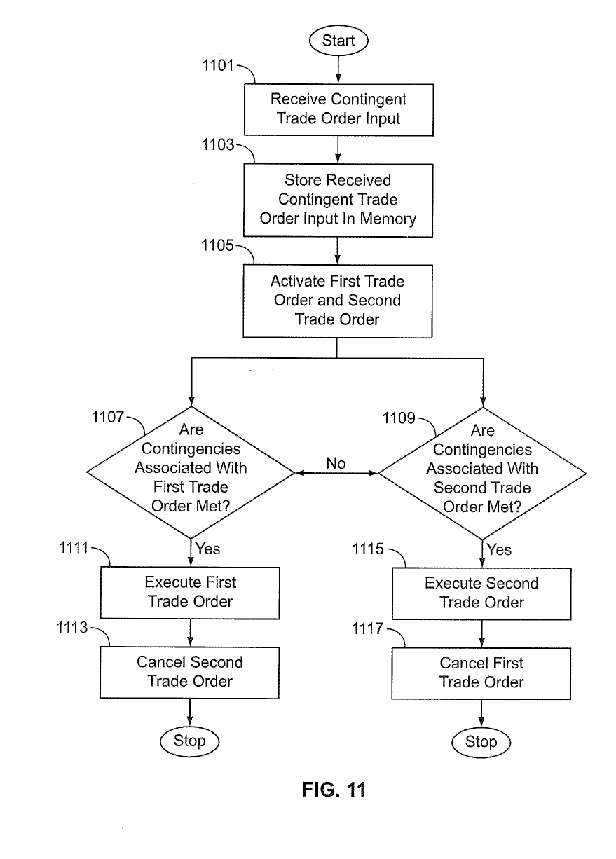

FIG. 11 is a one-cancels-other flowchart according to the present invention. The contingent trade order input is received 1101 and stored in memory 1103. Both the first trade order and second trade order are activated 1105. The contingencies associated with each trade order 1107, 1109 are monitored to determine if they are met. If the contingencies associated with the first trade order are met 1107, the first trade order is executed 1111 and the second trade order is cancelled 1113. If the contingencies associated with the second trade order are met 1109, the second trade order is executed 1115 and the first trade order is cancelled 1117.

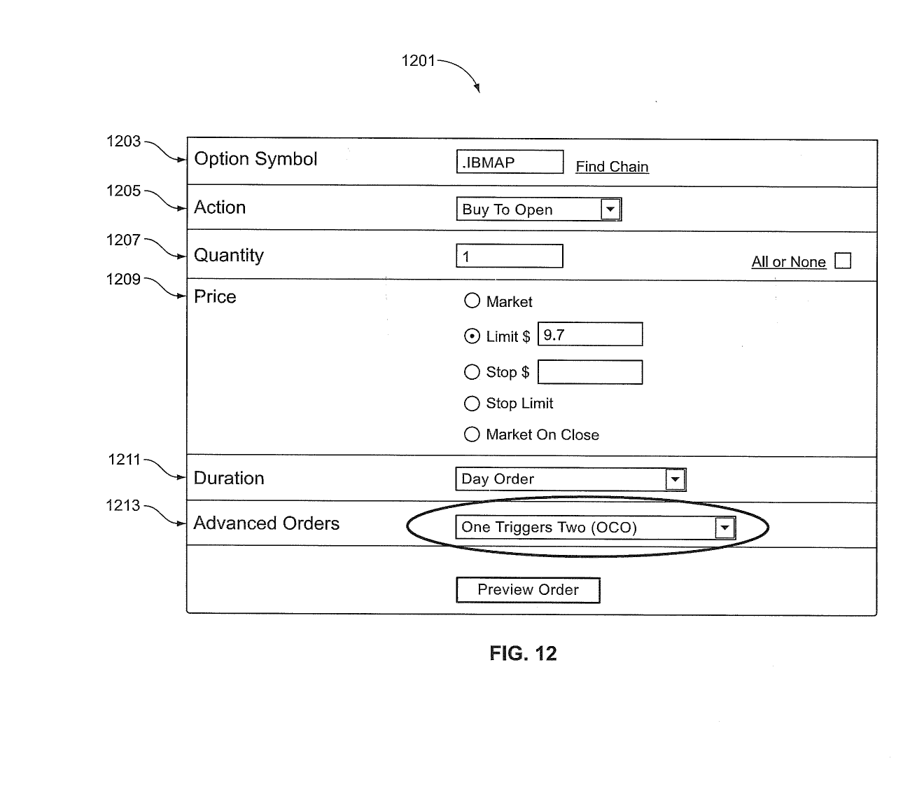

FIG. 12 is a one-triggers-two (OT2) order screen 1201 according to the present invention. The One Triggers Two (OT2) order-entry system allows an investor to enter a primary order and place two secondary orders that activate upon the complete fill of the primary order. Of these three orders, two execute. When one of the secondary orders is filled, a cancel order is triggered on the other. This new order-entry system is a combination of two advanced order features: One Triggers Other (OTO) and One Cancels Other (OCO) described above. OT2 can be utilized in various combinations when trading. OT2 order-entry systems are commonly used to limit losses or take gains on recently filled trades: enter an opening primary limit order to buy and two closing secondary orders to sell—one stop below and one limit above the current market prices.

An investor defines an order 1201. The order 1201 includes the stock or option symbol 1203 along with the action 1205. The order 1201 further includes the quantity 1207, price 1209 and duration 1211. The investor further selects the OCO for the advanced order 1213. With an OT2 trigger, a qualifier is used when multiple stock or option orders are entered and the execution of the first two orders cancels a third or alternate order.

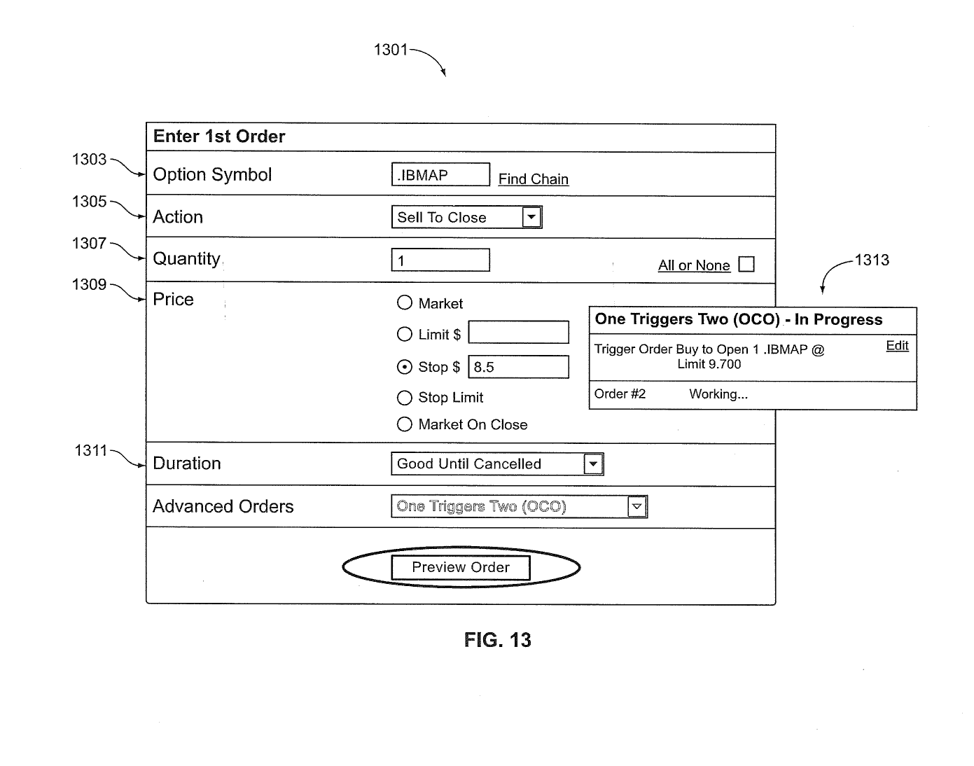

FIG. 13 is a one-triggers-two second order screen according to the present invention. A second order screen 1301 is displayed when the one-triggers-other is activated. An investor defines a second order 1301 that includes the stock or option symbol 1303 along with the action 1305. The order 1301 further includes the quantity 1307, price 1309 and duration 1311. The second order screen 1301 displays the first or primary order and its status, along with the second order and its status 1313.

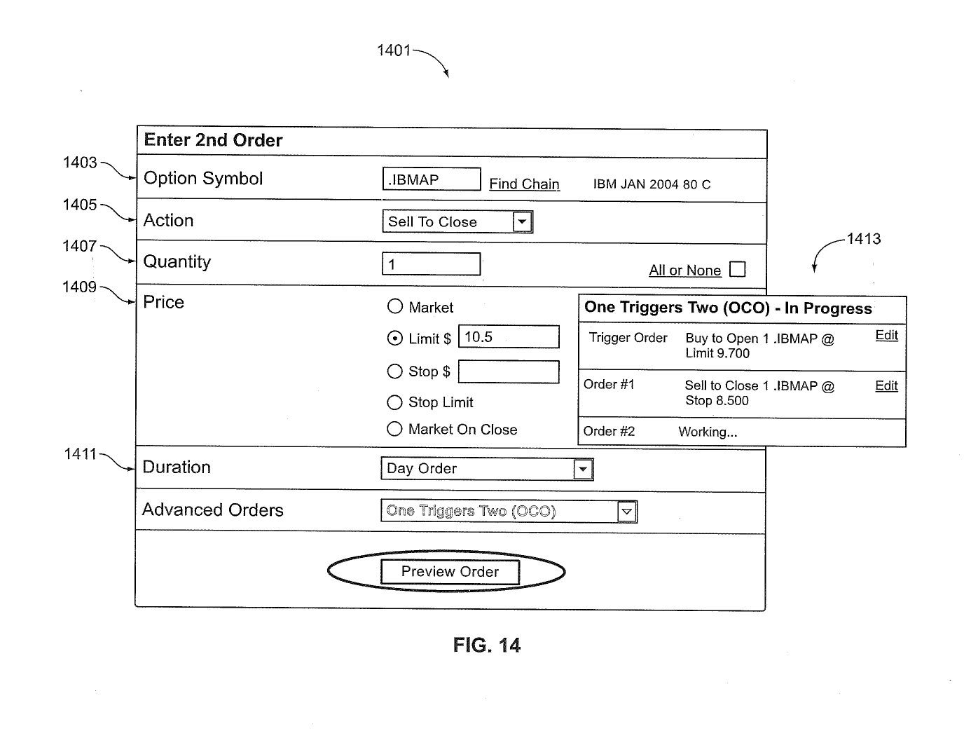

FIG. 14 is a one-triggers-two third order screen according to the present invention. A third order screen 1401 is displayed when the one-triggers-other is activated 1201 and subsequent to the second order screen 1301 being populated. An investor defines a third order 1401 that includes the stock or option symbol 1403 along with the action 1405. The order 1401 further includes the quantity 1407, price 1409 and duration 1411. The second order screen 1401 displays the first or primary order and its status 1313. The third order screen 1401 displays the first order and its status, with the second order and its status, along with the third order and it status 1413.

After the first order 1201 is executed, the second order 1301 and third order 1401 are activated. Either the second order 1301 is simultaneously canceled upon execution of the third order 1401, or the third order 1401 is simultaneously cancelled upon the execution of the second order 1301.

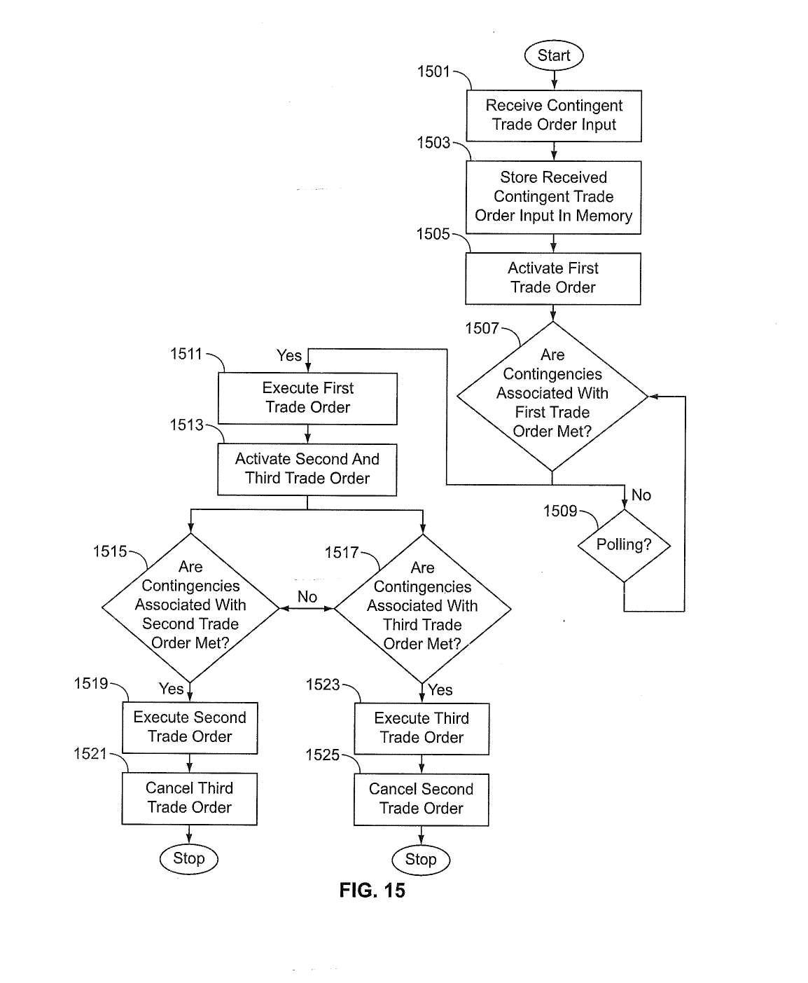

FIG. 15 is one-triggers-two flowchart according to the present invention. The contingent trade order input is received 1501 and stored into memory 1503. The first trade order is then activated 1505. The contingencies with the first trade order 1507 are polled 1509 until the contingencies are met. Once the contingencies are met 1507, the first trade order is executed 1511. Upon execution of the first trade order 1511, the second and third trade orders are simultaneously activated 1513. Both the second trade order and third trade order are polled 1515, 1517 to determine if contingencies associated with either order are met. If the contingencies associated with the second trade order are met 1515, the second trade order is executed 1519 and the third trade order is simultaneously cancelled 1521. If the contingencies associated with the third trade order are met 1517, the third trade order is executed 1523 and the second trade order is simultaneously cancelled 1525.

Thus, while the invention has been disclosed and described with respect to certain embodiments, those of skill in the art will recognize modifications, changes, other applications and the like which will nonetheless fall within the spirit and ambit of the invention, and the following claims are intended to capture such variations.

What is claimed is:

1. An interactive computerized online trading platform method for prioritized management of financial instruments comprising:
receiving an order through the interactive computerized online trading platform for trading a first financial instrument, a second financial instrument, and a third financial instrument;
accepting instructions specified by an individual investor through the interactive computerized online trading platform, wherein the instructions are to simultaneously activate a second trade of the second financial instrument and a third trade of the third financial instrument upon contingencies of a first trade of the first financial instrument being met, and either simultaneously cancelling the second trade when the third trade is executed or simultaneously cancelling the third trade when the second trade is executed; and
executing actions automatically through the interactive computerized online trading platform according to the instructions.
